(19) United States
(12) Patent Application Publication
(10) Pub. No.: US 2010/0241470 A1
(43) Pub. Date: Sep. 23, 2010

(54) SYSTEM AND APPARATUS FOR RAPID RECHARGING OF ELECTRIC BATTERIES

(76) Inventor: Christopher W. Smith, Oceanside, NY (US)

Correspondence Address: Christopher W Smith, 474 Windsor Place, Oceanside, NY, 11572, US

(21) Appl. No.: 12/406,844

(22) Filed: Mar. 18, 2009

(51) Int. Cl. G06Q 10/00; H02J 7/00; G06Q 50/00

(52) U.S. Cl. 705/7; 320/107; 705/28

(57) ABSTRACT

A system for rapid recharging of a battery includes a charging system including a first portion of a connector. A material exchange pipe is joined to the first portion. A pump passes battery materials through the material exchange pipe. A tank receives battery materials. A tank supplies battery materials. A vent pipe is joined to the first portion and is joinable to the receiving tank and to the supplying tank. A charge on battery material passing through the material exchange pipe is measured and a means receives data from the battery. A battery system includes a material level sensor. A data connection transmits the material levels to the receiving means. A material exchange pipe is joined to the battery and a second portion of the connector. A vent pipe is joined to the battery and the second portion where battery materials can be exchanged between the battery and charging systems.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to batteries. More particularly, the invention relates to a system and equipment for recharging electric batteries using chemical replacement.

### BACKGROUND OF THE INVENTION

Electric cars currently are only available to those who have the means to recharge them at their place of residence. Furthermore, batteries in electric cars currently have about a 300-mile limit before they need to be recharged. Typically to recharge these batteries, the vehicle must be plugged into a source of electricity for several hours without moving. There are many examples of battery systems where a battery has electrolytes or other materials fed into it from fresh reservoirs, and, once the materials are expended in the battery, the spent materials are stored on the vehicle. For the purposes of the present description, these storage tanks are considered part of the battery. The spent material in the tanks can be drained, and the fresh tanks can be refilled. For the purposes of consistency, all vehicle, appliances, and devices that contain these batteries are herein referred to simply as vehicles and all service and charging stations are herein referred to as charging stations.

Most battery patents are now written to recognize the fact that people will try to design methods for recharging the batteries by physically exchanging materials to restore electrical energy to the batteries. Some batteries can be recharged by replacing the electrolyte components; however, though designed to be drained, these batteries have no means of identifying the amounts of materials currently present in them and the types of material currently present in them.

There have been previous attempts to create a system to physically exchange materials to restore electrical energy to batteries. A prior art battery recharging system provides a system for an electric vehicle that recharges the energy content of the battery by pumping materials into tanks on the vehicle from pumps at a charging station. The system also extracts used materials that have been depleted of energy content from the battery. The system then returns these materials to the service station where they are recharged for use in other vehicles. However, these systems have no way of determining how much energy is remaining in the material received from the vehicle. Furthermore, though they are designed to be drained, these batteries do not concern themselves with the viability of the materials that are being drained and must, occasionally be extensively serviced to have solid reactants replaced, such as lead stacks or reactive anodes/cathodes.

In view of the foregoing, there is a need for improved techniques for recharging batteries by exchanging the material in the batteries that can determine the current amount of material in the batteries, the optimal capacity for material in the battery, the energy remaining in this material, relaying necessary information to the charging station, maintain a closed system, test for viability for redistribution of exchanged materials, and be adaptable to the ever changing technologies present in the energy market.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary battery recharging system, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a system and apparatus for rapid recharging of electric batteries is presented.

In one embodiment, a system for rapid recharging of a battery is presented. The system includes a charging system operable for charging battery materials. The charging system includes a first mating portion of a connector. At least one charging system material exchange pipe is joined to the first mating portion. At least one pump passes battery materials through the at least one charging system material exchange pipe. At least one tank receives battery materials from the at least one pump. At least one tank supplies battery materials to the at least one pump. At least one vent pipe is joined to the first mating portion and joinable to the at least one tank for receiving battery materials when receiving battery materials from the at least one pump and joinable to the at least one tank for supplying battery materials when supplying battery materials to the at least one pump. A means measures a charge on battery material passing through the at least one charging system material exchange pipe and a means receives data from the battery. A battery system includes at least one sensor for sensing material levels in the battery. A data connection at least transmits the material levels to the receiving means. At least one battery material exchange pipe is joined to the battery and a second mating portion of the connector. At least one battery vent pipe is joined to the battery and the second mating portion for equalizing pressure during battery material exchange, where, when the first and second mating portions are mated, battery fluids and gases present in the battery can be exchanged between the battery system and the charging system rapidly charging the battery.

In another embodiment a system for rapid recharging of an electric battery is presented. The system includes a charging system including means for receiving battery materials, means for supplying battery materials, means for venting during receiving and supplying battery materials, means for measuring a charge on battery materials, and means for receiving data from the battery. A battery system includes means for sensing material levels in the battery, means for transmitting data, means for exchanging battery materials and means for equalizing pressure during battery material exchange. Means for connections between the charging system and the battery system where battery fluids and gases present in the battery can be exchanged between the battery system and the charging system rapidly charging the battery.

In another embodiment an apparatus for rapid recharging of a battery is presented. The apparatus includes means for receiving battery fluids and gases present in the battery, means for supplying battery materials, means for venting during receiving and supplying battery materials, means for measuring a charge on battery materials and means for receiving data from the battery whereby battery materials can be exchanged between the battery and the apparatus for rapidly charging the battery.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Preferred embodiments of the present invention provide a system that is designed to be used to recharge batteries that contain no non-dissolved solid rechargeable elements, thus all the rechargeable elements can be replaced in this system via pumping fluids and gases thru pipes. This enables preferred embodiments to be applied to batteries whose structure must remain sealed at all times and greatly reduces the effort required by the person performing the exchange. In preferred embodiments, the battery comprises a sensor that measures the material levels in the battery. This sensor aids in the allocation of space in receptacles to receive materials from the vehicle and transmits a signal to a pump when the battery material has reach an optimal capacity, thus generally preventing overfill and not relying on the previous level of material to determine how much material is supplied. In preferred embodiments, in addition to material and gas transport piping, the system comprises a data connection in a standardized adapter that securely connects the vehicle to the charging station that can be used to communicate information such as, but not limited to, battery material levels, current charge, type of materials contained within the battery, etc.

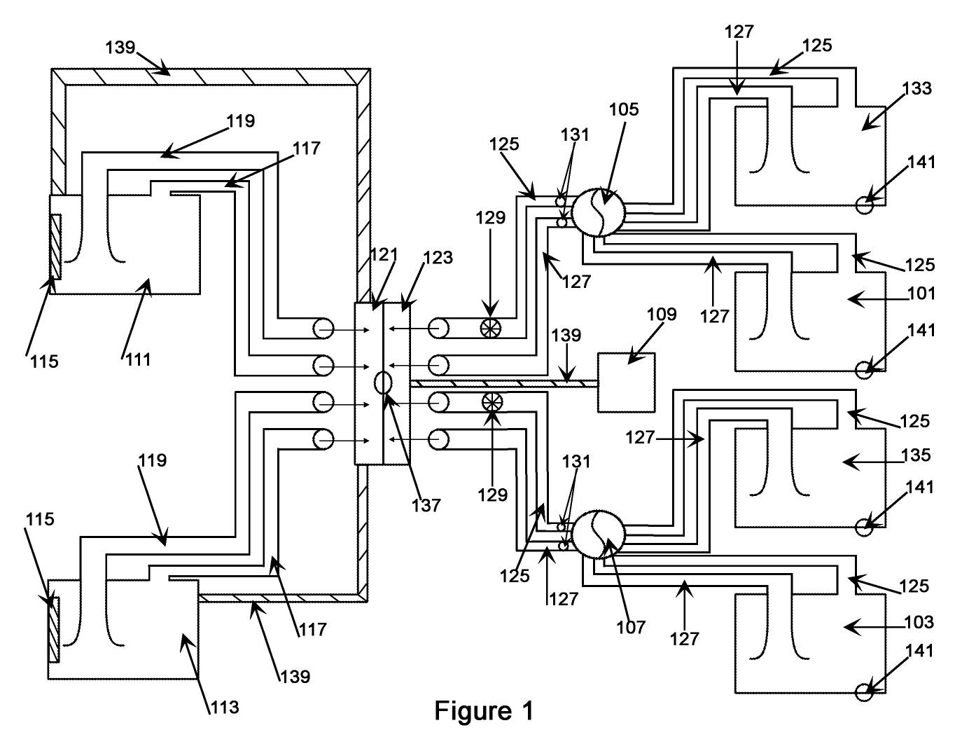

FIG. 1 illustrates an exemplary battery recharging system, in accordance with an embodiment of the present invention. In the present description, it is assumed that both discharged charger tanks at a charging station, a positive discharged charger tank 101 and a negative discharged charger tank 103, are empty, and a vehicle with an electric battery has just arrived at the charging station. Pumps 105 and 107 and a station computer 109 function much in the same way that current fuel pumps function. The charging station can recharge standard car batteries or other energy storage devices. In the present embodiment, the vehicle battery is an Electrochemical Cell where the electrodes are nonreactive; however, alternate embodiments may be implemented to recharge other types of batteries such as, but not limited to, a car battery that has fluid, gaseous, and/or dissolved solid, and/or solid components that must be removed and replaced, etc chemical components and batteries that are used in devices other than vehicles for example, without limitation, electronics, power tools, appliances, etc. In the present embodiment, the battery comprises a positive storage tank 111 and a negative storage tank 113, which hold the electrochemical storage materials. The positive and negative materials are stored in separate compartments, and the electrical work is done by energy flowing between positive storage tank 111 and negative storage tank 113. Positive storage tank 111 and negative storage tank 113 both contain a material level measurement device 115. Those skilled in the art, in light of the present teachings, will readily recognize that a multiplicity of suitable devices may be used as the material level measurement device; for example, without limitation, the device may be something as simple as a series of electrodes whose circuits are closed by the charged electrolytes.

Vent pipes 117 and material exchanging pipes 119 made of the same nonreactive, nonconductive material as the battery casing are attached to positive storage tank 111 and negative storage tank 113. Material exchanging pipes 119 are used initially to drain the discharged electrochemical storage materials from storage tanks 111 and 113 by pumps 105 and 107 while vent pipes 117 act as vents from tanks 133 and 135 via pipes 125 enabling the pressure in the battery to remain constant. After drainage is complete, recharged material is pumped into storage tanks 111 and 113 by pumps 105 and 107 through material exchanging pipes 119, and again vent pipes 117 act as vents to tanks 101 and 103 via pipes 125 for generally maintaining constant pressure inside the battery and enabling possible gaseous reactants to be effectively transfered.

In the present embodiment, an interface 121 at the side of the vehicle approximately where a gas cap would be connects the four pipes, positive and negative vent pipes 117 and positive and negative material exchanging pipes 119, to a charging station using secure methods. In alternate embodiments the means by which the connection is secured may vary and interfaces for connecting to recharging stations may be placed in various different locations on the vehicles, such as, but not limited to, on the hood, behind a license plate, underneath the vehicle, etc. In the present embodiment, interface 121 connects to a standard adaptor 123 at the charging station. There may be more than one material type being commonly used in batteries at any given time. Adapter 123 shows four pipes passing through it; however, alternate embodiments may comprise as many pipes as necessary to move all or most of the different types of material currently in market circulation. Furthermore, in some embodiments, adaptors may be made to be interchangeable to enable them to be changed to correspond to the materials in the battery being recharged or to be upgraded as the chemicals used in batteries change. The pipes that are used for a particular battery in these embodiments are determined after a data connection 137 informs the charging station what chemicals are currently contained in the battery.

In the present embodiment, all of the pipes are made of the same materials as the battery casing. Material exchanging pipes 125 lead from adaptor 123 to pumps 105 and 107 and then to positive discharged charger tank 101, negative discharged charger tank 103, a positive charged charger tank 133, and a negative charged charger tank 135 in the charging station and drain material from or add material to storage tanks 111 and 113, and vent pipes 127 maintain the pressure in the system. Material exchanging pipes 125 each comprise an energy-measuring device 129 for measuring the remaining energy in drained materials. This enables the cost of the recharge to be based on energy provided rather than the volume of material exchanged. However, alternate embodiments may base the cost of the recharge on the volume of material exchanged. In the present embodiment, energy-measuring device 129 measures the electric field generated by the moving ions in the material combined with the rate of material flow determined by pumps 105 and 107 to determine the average charge density of the material. However, those skilled in the art, in light of the present teachings, will readily recognize that a multiplicity of suitable means for measuring the energy in the material may be used in alternate embodiments such as, but not limited to, conductive contact applied to the pipes with voltmeter between positive and negative terminals. Material exchanging pipes 125 also comprise a volume-measuring device 131 so that the energy density can be multiplied by the volume pumped into the battery to determine the total energy provided. Material exchanging pipes 125 also comprise one-way valves that generally ensure that incoming and outgoing chemicals do not mix. The valves are shown in the pump at a Y joint to the right of the pressure generation. In the gaseous pipes when pressure pulls from the right only one valve will open and gasses will flow to the battery from the station and when pressure pulls from the left gasses will be pushed into the appropriate charger tank. The material valves would be the reverse of the gaseous ones to maintain proper directional flow.

The charging station comprises positive discharged charger tank 101 and negative discharged charger tank 103 to receive discharged material from the batteries pumped by pumps 105 and 107. The charging station also comprises means to connect the charging station to the utility power being provided to the building such as, but not limited to, an electric cord or a generator and an energy-measuring device to determine when the material in discharged charging tanks 101 and 103 is recharged. The preferred embodiment plugs directly into a socket or is hard wired into the buildings power supply; however, generators or any other power source could be used. Positive charged charger tank 133 and negative charged charger tank 135 hold recharged material, and pumps 105 and 107 pump the recharged material into material exchange pipes 125 into the battery. The charging station can then recharge the material in discharged charging tanks 101 and 103 received from the vehicle at its leisure and, after charging, pump this recharged material into another vehicle that needs charging.

In the case of most electric vehicles the battery is not a single battery, but rather a collection of batteries acting together. In this case all of the positive material pipes collect into a larger pipe before reaching the interface of the vehicle, all of the negative material pipes collect into a larger pipe before reaching the interface of the vehicle, all of the positive vent pipes collect into a larger pipe before reaching the interface of the vehicle, and all of the negative vent pipes collect into a larger pipe before reaching the interface of the vehicle. This enables the adaptor at the charging station to be a standardized exchange nozzle that may be used to change out the material on any vehicle using this technology regardless of the internal configuration or size of the battery.

The gases in vent pipes 117 and 127 that are being exchanged to equalize pressure are not released into the atmosphere during load or charge. Instead, the gases are contained in the battery until recharge or exchange and are allowed to flow from the charging device to the battery container and back again so that there is no loss of gaseous reactive components or evaporation from the electrochemical material that would adversely affect the material. This enables the battery to function as a sealed battery currently does in most vehicles.

In typical use of the present embodiment, a user can pull up to a charging station and be on his way in minutes rather than having to charge his vehicle for hours. At the charging station, flexible material exchanging pipes 125 and vent pipes 127 are secured to interface 121 on the vehicle with standardized adapter 123 and along with the data cable are contained in a single tube similar to the coaxial piped currently used for petroleum pumps with gas reclamation, though not necessary arranged in a coaxial layout. Data connection 137 is made between adaptor 123 and vehicle interface 121. Data cables 139 connect storage tanks 111 and 113 in the battery and station computer 109 to data connection 137, and information such as, but not limited to, material volume, charge, and electrolyte type is relayed from the battery to station computer 109 through data cables 139. Station computer 109 calculates the average charge density of the material in the battery and can then associate an approximate price per gallon, or other partial measurement, for the recharged material, a total recharge price, and the total volume of space needed in the recharger to contain the materials volumes about to be received. The user may then select an amount to charge, for example, without limitation, to fill a portion of the battery, to fill the whole battery, to pay a specific dollar amount, etc, as they currently do with gas pumps.

Pumps 105 and 107 then draw materials from positive storage tank 111 and negative storage tank 113 through material exchanging pipes 119 and 125 into the corresponding discharged recharger tank(s), positive discharged charger tank 101 or negative discharged charger tank 103, while the pressure is balanced with gas from charged charger tanks 133 and 135 through vent pipes 117 and 127. During the material drainage phase, storage tanks 111 and 113 on the vehicle are filled with only gases of the same type present in the battery during normal operation and electrical charging so as to generally ensure the presence of all necessary gaseous chemical components. As the material passes thru the pipes, voltage-measuring devices 129 confirm the charge reported by data cable 139, and pumps 105 and 107 track the volume of the material that has been extracted from storage tanks 111 and 113. This continues until a predetermined volume has been removed or until material level measuring devices 115 in the battery report, through data cable 139, that storage tanks 111 and 113 are emptied. Pumps 105 and 107 then draw material from charged charger tanks 133 and 135 through material exchanging pipes 125 and deposit the material in it into material exchanging pipes 119 to go to the appropriate battery cells, positive storage tank 111 or negative storage tank 113, while the gas is forced out of storage tanks 111 and 113 feeding into discharged charger tanks 101 and 103 through vent pipes 117 and 127. This process continues until the same predetermined amount of material has been reached or until material level measurement devices 115 indicate that storage tanks 111 and 113 have reached their optimum capacity. The use of material level measurement devices 115 generally prevents the overfilling of storage tanks 111 and 113 and allows for the measurement of drainage in the case that a predetermined amount has been selected. During the material replacement phase, the gases present in storage tanks 111 and 113 in the vehicle battery are to be passed to the same vessel that the material originally in the vehicle now occupies so as to provide any possible gaseous components to the recharging chemical reaction.

The newly filled discharged charger tanks 101 and 103 comprise all of the necessary components to electrically reverse the electrochemical reaction that powered the vehicle, and storage tanks 111 and 113 in the battery are now charged to whatever degree at which they are set to be, for example, without limitation, fully charged if fully exchanged. Adapter 123 and vehicle interface 121 now reseal and separate. The material in discharged charger tanks 101 and 103 is tested to determine if it is still viable to be recharged. The exact methodology of testing the discharged material is dependant upon the unclaimed chemistry of the materials being used. If the material is viable, the material is recharged, and if not, the material is drained through drainage valves 141 and charger tanks 101 and 103 are refilled with fresh material. Also, if discharged charger tank 101 or 103 is not completely full, it is topped off with fresh material. Discharged charger tanks 101 and 103 are electronically recharged, and the cycle is repeated with discharged charger tanks 101 and 103 being the charged tanks and charged charger tanks 133 and 135 being the discharged charger tanks for the next vehicle.

Because of the drained stage intermediary in the present embodiment, the battery can be installed empty and filled at a later time, or the refill can be postponed to allow maintenance to be performed on the empty shell of the battery. In the present embodiment, there are no tanks for spent or charged electrochemical material in the vehicle outside of the battery. However alternate embodiments may comprise storage tanks outside of the battery for electrochemical material.

In the present embodiment, as the electrochemical materials are being drained from the battery system on board the vehicle and before the material is passed into the charging unit, the remaining charge on the electrolyte components in the material are measured. As this portion of the charge does not need to be electrically recharged by the charging station before the material is redistributed to another vehicle, this quantity of charge can be subtracted from the quantity of the charge being provided to the vehicle by the charging station, which is measured as well before it passes into the vehicle. This additional measurement allows for accurate measurement of charge exchanged and thus enables the charging station to accurately assess the value of the service being provided without relying on the accuracy of measuring devices contained in the vehicle. There are many methods known to those skilled in the art for measuring charge, and the exact methodology used to measure the charge may vary in various embodiments of the present invention. Electric cars typically monitor the amount of energy left in their batteries, and in the present embodiment, the system sends this information to the charging station along with the volume of material in the batteries so that an approximate cost can be assessed before recharging. This enables the customer to decide to do a partial exchange for a portion of the total cost if the total cost is more than the customer wishes to pay. In the present embodiment, pumps 105 and 107 and other measuring devices in the charging station also perform the detection of the pumping force, the remaining charge measurement, and the fill level measurement since most energy suppliers would not want to rely on possibly faulty measurements from a customer's vehicle when determining what to charge the customer.

It is likely that an electrical vehicle has components that cannot or should not be without power during the exchange of electrochemical material, and as such in the preferred embodiment, one cell in the series of battery cells is not connected to the material exchange system. This cell instead powers the vehicle components during the exchange and is electrically recharged by the newly refilled cells after the recharging is completed.

A wide variety of batteries may be recharged by preferred embodiments of the present invention; however there are some stipulations on the structure and chemistry of batteries that may be used. No non-dissolved solids can be part of the chemical reactions produced in the batteries to generate electricity, thus all of the rechargeable elements may be replaced by pumping fluid and/or gases through pipes. However, the electrodes in the batteries obviously still must be solid, but as they are nonreactive and simply supply a means of electrical energy transport are not pertinent to the conversation of the batteries chemical makeup. This enables preferred embodiments of the present invention to be applied to batteries with structures that must remain sealed. As such, there is no need to periodically replace an oxidizable stack in a battery recharged by a preferred embodiment of the present invention as all oxidizable components are replaced during the exchange at the charging station. Fuel Cell Batteries with reversible chemical reactions are a good example of the types of reactants that are suitable for use with preferred embodiments of the present invention. In preferred embodiments, the battery casing on both the charging station charger and the vehicle battery are made of non-conductive materials that are non-reactive to the unclaimed material reactants. When exchanging materials at the charging station using preferred embodiments of the recharging system, pipes connect to the service station charging vessel for contained gaseous pressure equalization and chemical exchange. This preserves any gaseous byproducts of the discharge reaction and transports these gaseous byproducts to be present during the electrical recharge. Therefore, batteries at both the charging station and in the vehicle must have ports through which fluids and gases can flow as described above in preferred embodiments. Although in preferred embodiments the design of the system is such that the vehicles' batteries can be recharged by physical interchange of materials, batteries that may be recharged by preferred embodiments can also be electrically recharged in the same fashion as current batteries that cannot have their materials swapped.

The REDOX Flow Cells given as the battery type in a prior art recharging system generally have an oxidizable metal stack in them. Such a stack would have to be periodically replaced as the materials collected at the charging station would transfer the oxidized metal with the electrolytes. These solid stacks cannot be pumped back in to the storage tanks, and replacement would be a periodic lengthy service of the vehicle or device. Preferred embodiments of the present invention use batteries that do not have externally stored electrolytes being supplied and removed to the cell in an ongoing process, as it has no tanks. In those embodiments, the tanks are electrolyte tanks that are constantly flowing fresh electrolyte from fresh tanks thru the battery then into spent tanks. In the preferred embodiment, a basic battery design more similar to Fuel Cells is used and not batteries that flow electrolyte. Furthermore, the prior art describes pumps in the batteries that force used electrolytes to exit the batteries. In preferred embodiments of the present invention, the pumps that pump the electrolytes are part of the charging station rather than the vehicle battery and thus have no effect on the system during load bearing.

In a basic embodiment of the present invention, the system simply removes the discharged material from the battery and replaces the material with charged material while allowing gas to flow as described to equalize pressures within the system. This embodiment does not measure quantities such as, but not limited to, volumes or voltages, and thus has limited commercial applications as there is no way to determine the quantity of charge exchanged and thus no way to determine a price. However, this embodiment may be desirable for non-commercial applications, for example, without limitation, for residential use by individuals owning an electric vehicle or for use by entities owning a fleet of electric vehicles.

Alternate embodiments may be implemented that use materials other than battery acid such as, but not limited to, Methyltetrahydrofuran-Lithium Hexafluoroarsenate Batteries, Lithium Ion, lead-acid. In these embodiments the same principles of using nonreactive, nonconductive containers and pipes still hold, and the containers and pipes must be nonreactive and nonconductive to the material placed inside of the battery. Also, the gas may need to be replaced with a gas that is also nonreactive to the alternative material. Though these batteries would have to have the periodic replacement of stack and/or electrically reactive terminals.

In other alternate embodiments, the interface and adaptor that connect the vehicle to the charging station may be altered in any number of ways while still providing the same basic function of securely transferring gases and fluids between the battery and the charging device. In alternate embodiments, the adaptor could have more pipes that would align to pipes for the different chemicals in different locations; its materials could be altered to prevent reaction. Furthermore, alternate embodiments of the present invention may implement various different means for recharging the discharged electrochemical material, including, but not limited to, a slight variation on current car battery chargers, etc., as there are many ways known to those skilled in the art to recharge electrochemical material.

Having fully described at least one embodiment of the present invention, other equivalent or alternative methods of providing a system for recharging electric batteries using chemical replacement according to the present invention will be apparent to those skilled in the art. The invention has been described above by way of illustration, and the specific embodiments disclosed are not intended to limit the invention to the particular forms disclosed. For example, the particular implementation of the charging station may vary depending upon the particular type of battery used. The charging stations described in the foregoing were directed to implementations with four charging tanks to accommodate batteries with one type of positive material and one type of negative material; however, similar techniques are to provide charging stations with more charging tanks to accommodate various types of batteries with multiple different types of electrochemical materials or to be able to maintain a high quantity of charged materials on site or a high quantity of empty receptacles in the rotation of this discharged/charged cycle. Implementations of the present invention comprising more charging tanks are contemplated as within the scope of the present invention. The invention is thus to cover all modifications, equivalents, and alternatives falling within the spirit and scope of the following claims.

What is claimed is:

1. A system for rapid recharging of a battery, the system comprising:
a charging system operable for charging battery materials, said charging system comprising: a first mating portion of a connector; at least one charging system material exchange pipe joined to said first mating portion; at least one pump for passing battery materials through said at least one charging system material exchange pipe; at least one tank for receiving battery materials from said at least one pump; at least one tank for supplying battery materials to said at least one pump; at least one vent pipe joined to said first mating portion and joinable to said at least one tank for receiving battery materials when receiving battery materials from said at least one pump and joinable to said at least one tank for supplying battery materials when supplying battery materials to said at least one pump; means for measuring a charge on battery material passing through said at least one charging system material exchange pipe; and means for receiving data from the battery; and
a battery system comprising: at least one sensor for sensing material levels in the battery; a data connection for at least transmitting said material levels to said receiving means; at least one battery material exchange pipe joined to the battery and a second mating portion of said connector; and at least one battery vent pipe joined to the battery and said second mating portion for equalizing pressure during battery material exchange, where, when said first and second mating portions are mated, battery materials can be exchanged between said battery system and said charging system rapidly charging the battery.

2. The system as recited in claim 1, wherein said charging system further comprises means for measuring a volume of battery materials passing through said at least one charging system material exchange pipe.

3. The system as recited in claim 1, wherein said data connection further transmits a signal to said charging system when said battery material has reach an optimal capacity during exchange, thereby preventing overfill.

4. The system as recited in claim 1, wherein said data connection further transmits a chemistry of material contained in the battery to said receiving means.

5. The system as recited in claim 4, wherein said charging system further comprises at least one additional tank for supplying battery materials and said charging system chooses an appropriate tank for supplying battery materials based on said chemistry.

6. The system as recited in claim 1, wherein said data connection further transmits a current charge of battery materials and said charging system estimates a cost for recharging said battery system based in part on said current charge and said material levels.

7. The system as recited in claim 6, wherein battery materials are partially exchanged in part based on said estimated cost.

8. The system as recited in claim 2, wherein said charging system at least, in part, uses said volume and a difference in charge on battery material received and supplied to determine a total cost for recharging said battery system.

9. The system as recited in claim 1, wherein said battery system is contained in a vehicle.

10. The system as recited in claim 9, wherein said battery system further comprises at least one battery cell separate from said at least one battery material exchange pipe for powering components of said vehicle during the recharging.

11. The system as recited in claim 1, wherein said connector is a standardized connector and said data connection passes through said standardized connector.

12. The system as recited in claim 1, wherein said battery system further comprises electrochemical cells.

13. A system for rapid recharging of an electric battery, the system comprising:
a charging system comprising: means for receiving battery materials; means for supplying battery materials; means for venting during receiving and supplying battery materials; means for measuring a charge on battery materials; and means for receiving data from the battery;
a battery system comprising: means for sensing material levels in the battery; means for transmitting data; means for exchanging battery materials; and means for equalizing pressure during battery material exchange; and
means for connecting said charging system and said battery system where battery materials can be exchanged between said battery system and said charging system rapidly charging the battery.

14. The system as recited in claim 13, wherein said charging system further comprises means for measuring a volume of battery materials.

15. The system as recited in claim 13, wherein said charging system further comprises means for estimating a cost for recharging said battery system.

16. The system as recited in claim 14, wherein said charging system further comprises means for determining a total cost for recharging said battery system.

17. An apparatus for rapid recharging of a battery, the apparatus comprising:
means for receiving battery materials;
means for supplying battery materials;
means for venting during receiving and supplying battery materials;
means for measuring a charge on battery materials; and
means for receiving data from the battery whereby battery materials can be exchanged between the battery and the apparatus for rapidly charging the battery.

18. The apparatus as recited in claim 17, further comprising means for measuring a volume of battery materials.

19. The apparatus as recited in claim 17, further comprising means for estimating a cost for recharging the battery.

20. The apparatus as recited in claim 18, further comprising means for determining a total cost for recharging the battery.
